(19) United States
(12) Patent Application Publication
(10) Pub. No.: US 2014/0134473 A1
(43) Pub. Date: May 15, 2014

(54) ELECTRICAL INTERCONNECT AND METHOD OF ASSEMBLING A RECHARGEABLE BATTERY

(71) Applicant: GENERAL ELECTRIC COMPANY, Schenectady, NY (US)

(72) Inventors: Kristopher John FRUTSCHY, Schenectady, NY (US); Bhat Radhakrishna BADEKILA, Mangalore (IN); Alec Roger TILLEY, Ashbourne (GB); Thomas R. RABER, Schenectady, NY (US); William H. SCHANK, Howell, MI (US)

(73) Assignee: GENERAL ELECTRIC COMPANY, Schenectady, NY (US)

(21) Appl. No.: 13/676,485

(22) Filed: Nov. 14, 2012

(51) Int. Cl. H01M 2/20; H01M 2/30

(52) U.S. Cl. CPC H01M 2/202; H01M 2/30
USPC 429/158; 439/887; 29/623.1; 228/160; 228/179.1; 219/121.14

(57) ABSTRACT

An electrical interconnect is disclosed that includes an inner conductive material having a top surface and a bottom surface; and an outer conductive material different from the inner conductive material, wherein the outer conductive material is clad on the top and bottom surfaces of the inner conductive material, wherein the electrical interconnect is configured to be secured to a first terminal of a first electrochemical cell and a second terminal of a second electrochemical cell. A method of manufacturing an electrical interconnect is also disclosed.

### BACKGROUND

1. Technical Field

Embodiments of the subject matter disclosed herein relate to electrical interconnects for connecting a terminal of an electrochemical cell of a rechargeable battery to a terminal of another electrochemical cell of the rechargeable battery.

2. Discussion of Art

Rechargeable batteries include a plurality of energy storage cells connected in series by electrical interconnects. Interconnects provide an electrical connection between the negative terminal of one energy storage cell to the positive terminal of the next energy storage cell in the series. The resistance of prior interconnects has reduced the efficiency of rechargeable battery systems and may have necessitated additional energy storage cells to compensate for the losses introduced by the interconnects. In addition, interconnects have been costly to manufacture due to the high temperature and potentially corrosive environment that may exist inside a rechargeable battery.

It may, therefore, be desirable to have an electrical interconnect for use in a rechargeable battery that differs from those that are currently available.

### BRIEF DESCRIPTION

Presently disclosed is an electrical interconnect. In an embodiment, the electrical interconnect includes a first portion configured to be secured to a first terminal of a first electrochemical cell, wherein the first portion comprises a first conductive material, and a second portion configured to be secured to a second terminal of a second electrochemical cell, wherein the second portion comprises a second conductive material. The first conductive material is different than the second conductive material.

In another embodiment, the electrical interconnect includes an inner conductive material having a top surface and a bottom surface, an outer conductive material different from the inner conductive material, wherein the outer conductive material is clad on the top and bottom surfaces of the inner conductive material. The interconnect is configured to be secured to a first terminal of a first electrochemical cell and a second terminal of a second electrochemical cell.

In another embodiment, a method of manufacturing an electrical interconnect includes providing a sheet of a first conductive material having a top surface and a bottom surface, and cladding the top surface and the bottom surface of the first conductive material with a second conductive material to form a clad sheet, wherein the second conductive material is different than the first conductive material. The method further comprises cutting the clad sheet into a plurality of electrical interconnects, coating each of the plurality of electrical interconnects with a corrosion resistant coating, and annealing each of the plurality of electrical interconnects.

In another embodiment, a method of manufacturing an electrical interconnect includes joining a first conductive material to a second conductive material to form a hybrid strip, cutting the hybrid strip to form a plurality of electrical interconnects, coating each of the plurality of interconnects with a corrosion resistant coating, and annealing each of the plurality of electrical interconnects.

In another embodiment, a method of assembling a rechargeable battery includes providing a plurality of electrochemical cells, each cell having a first terminal and a second terminal, and providing a plurality of electrical interconnects, each electrical interconnect having a first portion and a second portion. The first portion of each of the electrical interconnects comprises a first conductive material and the second portion of each of the electrical interconnects comprises a second conductive material different than the first conductive material. The method further includes securing the first portion of one of the electrical interconnects to a first terminal of one of the electrochemical cells, and securing the second portion of said one of the electrical interconnects to a second terminal of a different one of the electrochemical cells.

In another embodiment, a rechargeable battery includes a plurality of electrochemical cells, each cell having a first terminal and a second terminal, and a plurality of electrical interconnects, wherein each electrical interconnect comprises a first portion secured to the first terminal of one of the electrochemical cells, and a second portion secured to the second terminal of a different one of the electrochemical cells. The first portion of each of the electrical interconnects comprises a first conductive material and the second portion of each of the electrical interconnects comprises a second conductive material different than the first conductive material.

In another embodiment, a method of assembling a rechargeable battery includes providing a plurality of electrochemical cells, each cell having a first terminal and a second terminal, and providing a plurality of electrical interconnects, each interconnect having a first portion configured to be secured to the first terminal of one of the electrochemical cells, and a second portion configured to be secured to the second terminal of a different one of the electrochemical cells. Each of the plurality of electrical interconnects comprises a sheet of an inner conductive material clad with sheets of an outer conductive material, wherein the inner conductive material is different than the outer conductive material. The method further comprises securing the first portion of one of the electrical interconnects to the first terminal of said one of the electrochemical cells, and securing the second portion of said one of the electrical interconnects to the second terminal of said different one of the electrochemical cells.

In another embodiment, a rechargeable battery includes a plurality of electrochemical cells, each cell having a first terminal and a second terminal. The rechargeable battery further comprises a plurality of electrical interconnects, each interconnect having a first portion secured to the first terminal of one of the electrochemical cells, and a second portion secured to the second terminal of a different one of the electrochemical cells. Each of the plurality of electrical interconnects comprises a sheet of an inner conductive material clad on opposite sides with sheets of an outer conductive material, wherein the inner conductive material is different than the outer conductive material.

### BRIEF DESCRIPTION OF THE DRAWINGS

Reference is made to the accompanying drawings in which particular embodiments and further benefits of the invention are illustrated as described in more detail in the description below in which:

FIG. 1 is a perspective view of an electrical interconnect in use with electrochemical cells of a rechargeable battery;

FIG. 2 is a perspective view of an embodiment of an electrical interconnect;

FIG. 3 is a perspective view of another embodiment of an electrical interconnect;

FIG. 4 is a cross-section of the electrical interconnect of FIG. 2 along section line 4-4.

FIG. 5 is a top view of a hybrid strip for manufacturing electrical interconnects;

FIG. 6 is a cross-section view of another embodiment of an electrical interconnect that includes a coating;

FIG. 7 is a cross-section view of an embodiment of a clad electrical interconnect;

FIG. 8 is a graph of total cell resistance including the interconnect for an embodiment of an electrical interconnect according to the present disclosure and a prior art nickel interconnect;

FIG. 9 is a test setup for measuring voltage drop across a selection of interconnects; and

FIG. 10 is a graph of voltage vs. position at fixed electrical current from for a prior art mild steel interconnect and several embodiments of an electrical interconnect according to the present disclosure.

### DETAILED DESCRIPTION

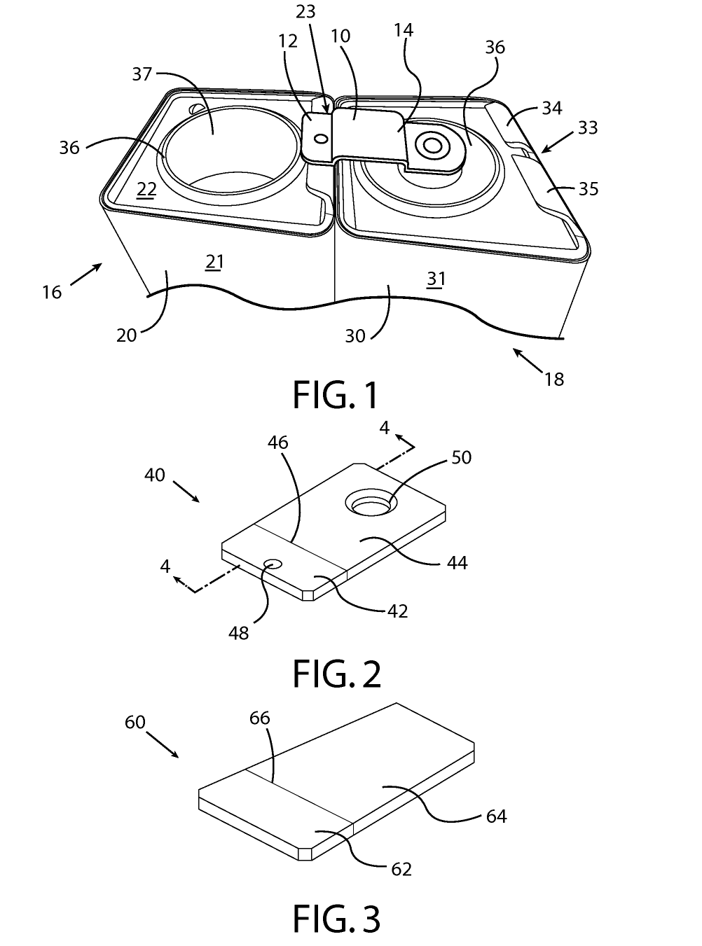

The subject matter presently disclosed relates to a low resistance electrical interconnect for connecting a terminal of an electrochemical cell of a rechargeable battery to a terminal of another electrochemical cell of the rechargeable battery. Referring to FIGS. 1 through 10, embodiments of an electrical interconnect are illustrated. A rechargeable battery may be constructed from a wide variety of electrochemical cells, such as sodium-halide, sodium-sulfur, lithium-sulfur, and other available electrochemical cells used for energy storage. In one embodiment, the electrochemical cells have an operating temperature determined by the melting point of the materials utilized in the cells. For example, the operating temperature may be greater than about 100 degrees Celsius, such as between (and including) 250 degrees Celsius and 400 degrees Celsius, or between (and including) 400 degrees Celsius and 700 degrees Celsius, but other desired operating temperature are also possible.

In some embodiments, the electrochemical cells (sometimes referred to as energy storage cells) can have dimensions of about 37 mm×27 mm×240 mm, any of which dimensions may vary by up to +/−50%, in accordance with various embodiments. In other embodiments, the dimensions of the energy storage cell may vary as desired to support the electrochemical cell for a given application. In embodiments, the chemistry of a cell is of the sodium-metal-halide type, in which NaCl and Ni are converted to Na and NiCl₂ during battery charging. The energy capacity of a cell can range from about 30 amp*hours to about 250 amp*hours.

To provide greater energy storage capacity and greater output voltage, a rechargeable battery often includes a plurality of electrochemical cells connected in series. Electrical interconnects are used to connect the positive terminal of one electrochemical cell to the negative terminal of the next electrochemical cell in the series. In embodiments, an electrical interconnect includes a first portion configured to be secured to a first terminal of a first electrochemical cell and a second portion configured to be secured to a second terminal of a second electrochemical cell. The first portion and the second portion of the electrical interconnect are each formed of a conductive material, however, the conductive material of the first portion is different that the conductive material of the second interconnect. In some embodiments, an electrical interconnect constructed of different conductive materials may be referred to as a hybrid interconnect.

Referring now to FIG. 1, an embodiment of an electrical interconnect 10 is illustrated in use with a first electrochemical cell 16 and a second electrochemical cell 18. For purposes of illustration, only one interconnect 10 is illustrated, however, in a rechargeable battery having a plurality of cells connected in series, plural interconnects 10 connect the cells to one another in series, with the first and last cells typically connected to a bus bar or otherwise connected to the external terminals of the rechargeable battery. That is, a first electrical interconnect connects a second terminal (e.g., negative terminal) of a first cell to a first terminal (e.g., positive terminal) of a second cell, a second electrical interconnect connects a second terminal of the second cell to a first terminal of a third cell, and so on.

The first electrochemical cell 16 includes a cell housing 20 having cell walls 21 and a terminal body 22 secured to the cell housing to retain the components of the electrochemical cell. In some embodiments, the cell housing is electrically conductively connected to one of the terminals of the electrochemical cell. In other embodiments, the housing is insulated from the cell terminals. The second electrochemical cell 18 similarly includes a cell housing 30 having cell walls 31 and a terminal body 32 secured to the cell housing.

The first electrochemical cell 16 and the second electrochemical cell 18 each include a first terminal and a second terminal. In embodiments, the first terminal of each cell is the negative terminal, while the second terminal is the positive terminal. In other embodiments, the first terminal may be the positive terminal while the second terminal is the negative terminal of the cell. In one embodiment, the first terminal 23, 33 of the cells extends from a peripheral edge of the respective terminal body 22, 32. As shown on the second electrochemical cell 18, the first terminal 33 may include a first tab 34 and a second tab 35. In this manner, the first terminal 33 is electrically conductively connected to the terminal body 32, the cell walls 31, and the cell housing 30. In embodiments, the first terminal 33, terminal body 32, and cell housing 30 of the electrochemical cell is formed of a steel, such as mild steel. Steel provides a variety of benefits including mechanical strength for the cell housing, terminal body, and first terminal, as well as a relatively low cost as compared to other conductive materials.

As shown on the first electrochemical cell 16, the second terminal 26 of the first electrochemical cell 16 may extend through an aperture 28 in the terminal body 22 such that the second terminal 26 is electrically isolated from the terminal body 22 and the first terminal 23 of the cell. In embodiments, the second terminal 26 may further include a closure cap 27 configured to close the electrochemical cell such that the cell chemistry is retained in the cell after assembly of an individual cell. Some embodiments of electrochemical cells may also include a sealable vacuum port such that the interior of the cell may be substantially evacuated prior to sealing of the cell. In embodiments, the second terminal 26, which may include a closure cap 27, is formed of a nickel, such as nickel-201, or a nickel alloy. Nickel and nickel alloys are reliably weldable to a variety of materials facilitating assembly of the rechargeable battery.

The electrical interconnect 10 includes a first portion 12 and a second portion 14 as illustrated in FIG. 1. The first portion 12 of the electrical interconnect 10 is secured to the first terminal 23 of the first electrochemical cell 16. The second portion 14 of the electrical interconnect 10 is secured to the second terminal 26 of the second electrochemical cell 18. In this manner, the electrical interconnect 10 connects the electrochemical cells in series as part of a string of electrochemical cells that make up a rechargeable battery.

A rechargeable battery may be used in wide range of applications and in a range of operating environments. Vibrations, shocks, and other disturbances tend to generate movement of the electrochemical cells within the rechargeable battery that stress the interconnects. In various embodiments, to ensure a reliable connection between the electrical interconnect and the electrochemical cells, the first portion 12 is welded to the first terminal, and the second portion 14 is welded to the second terminal 36 during the assembly of the rechargeable battery. A variety of weld processes may be used to secure the interconnect to the first terminal and/or second terminal. In embodiments, the weld is created by a laser weld process, a resistance weld process, an electron beam weld process, a plasma arc weld process, a tungsten inert gas weld process, a wire weld process, a solder weld process, or any other appropriate welding technique. As used herein, the term “welding” may also include sonic or ultrasonic welding, or solid state welding. Moreover, the electrical interconnect may be bent or deformed depending upon the configuration of the terminals of the electrochemical cells to be connected to provide additional bending stiffness or provide clearance inside the battery compartment. As shown in FIG. 1, the electrical interconnect 10 is shaped to provide clearance over the edge of the cell housing while maintaining a substantially planar interface for welding the interconnect to the first terminal and the second terminal of the electrochemical cells.

Referring now to FIGS. 2-4, embodiments of electrical interconnects 40 are illustrated. The electrical interconnect 40 includes a first portion 42 configured to be secured to a first terminal of a first electrochemical cell, and a second portion 44 configured to be secured to a second terminal of a second electrochemical cell. The first portion. The electrical interconnect 40 is formed of at least two different conductive materials joined by a seam 46. In an embodiment, the first portion 42 is formed of a first conductive material while the second portion 44 is a second conductive material different than the first conductive material.

In embodiments, the shape of the electrical interconnect is adapted based on the configuration of the terminals of the electrochemical cells to be connected. In one embodiment, an electrical interconnect 40 has a substantially rectangular configuration, such that the width of the first portion 42 and the width of the second portion 44 are substantially uniform along the length of the interconnect. In some embodiments, a substantially rectangular configuration may provide a lower total resistance for the electrical interconnect providing improved performance of a rechargeable battery using the electrical interconnect. In embodiments, the electrical interconnect 40 may be further adapted to conform to the geometry of the terminals of the electrochemical cells. An electrical interconnect 40 may include an aperture 48 in the first portion 42. The aperture 48 may be configured to receive a portion of a first terminal. In one embodiment, a first terminal may include a pin that extends into the aperture 48 to assist in positioning the electrical interconnect during assembly of the rechargeable battery. In other embodiments, the electrical interconnect 40 may include an aperture 50 in the second portion 44. The aperture 50 may be configured to receive at least a portion of a second terminal. In one embodiment, a closure cap, such as illustrated in FIG. 1, may be received in the aperture 50 before the second portion 44 is secured to a second terminal of the electrochemical cell, such as by welding.

Referring now to FIG. 3, another embodiment of an electrical interconnect 60 is illustrated having a generally trapezoidal shape, in which the width of the interconnect tapers along the length, such that the second portion 64 of the interconnect has a narrower width than the first portion 42. The first portion 62 is joined to the second portion 64 by a seam 66, and the electrical interconnect may be provided with, or without, apertures as previously discussed. A trapezoidal shape may facilitate placement of the electrical interconnect if one of the terminals of the electrochemical cell has less clearance than the other terminal.

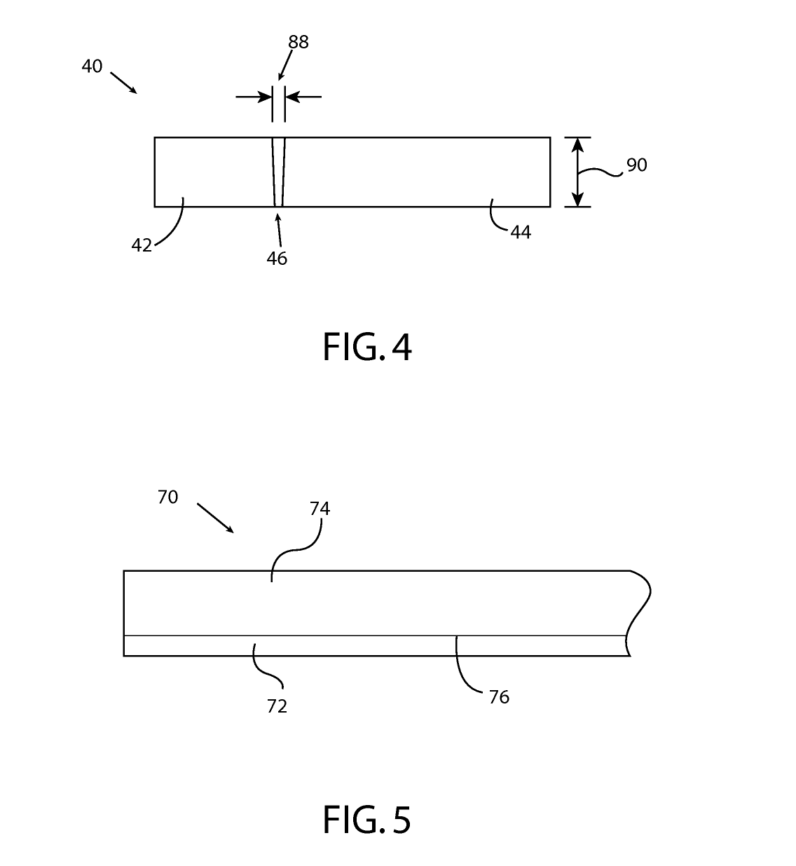

Referring now to FIG. 4, a cross-section of the electrical interconnect 40 of FIG. 2 is illustrated. The electrical interconnect is formed of two different conductive materials joined by a seam 66. In embodiments, the first portion 42 is formed of nickel, such as nickel-201, or a nickel alloy. Nickel and nickel alloys are reliably weldable to a variety of materials, including steel such as may be used in housing and first terminal of an electrochemical cell. While nickel and its alloys are reliably weldable and corrosion resistant, they provide greater electrical resistance reducing the efficiency of a rechargeable battery. In other embodiments, the first portion 42 may formed of nichrome, chromium, chromium alloys, or other metals that are weldable to steels. In embodiments, an electrochemical cell has a mild steel case which forms one of the terminals of the cell. An electrical interconnect having a nickel portion may be welded to the mild steel of the cell case providing a reliable weld to the cell case and the second portion of the electrical interconnect. In this manner, the materials of the electrical interconnect may be selected to facilitate manufacture of a rechargeable battery while reducing losses associated with the interconnect. To facilitate assembly of a rechargeable battery, the length of the first portion may be selected to provide a sufficient amount of the first conductive material to form a reliable weld to a first terminal of an electrochemical cell. In an embodiment, the length of the first portion 42 is from 10% to 50% of the overall length of the electrical interconnect as measured between a first end and a second end. In other embodiments, the length of the first portion 42 is from 10% to 30% of the overall length of the electrical interconnect.

The second portion 44 of the interconnect is formed of a different electrically conductive material than the first portion 42. In embodiments, the second portion 44 is formed of copper. Copper is highly conductive but subject to corrosion, particularly when exposed to battery liquid electrolyte at elevated temperatures such as may occur within a rechargeable battery. In another embodiment, the second portion is formed of a copper-beryllium alloy. In one embodiment, the copper-beryllium alloy includes approximately 0.4% by weight beryllium, such as between 0.3% and 0.5%. In another embodiment, the copper-beryllium alloy includes 1.9% by weight beryllium, such as between 1.8% and 2.0%. In other embodiments, a copper-beryllium alloy may include between 0.2% and 2.5% by weight beryllium. A copper-beryllium alloy provides improved conductivity as compared to nickel or nickel alloys, and also provides improved corrosion resistance and mechanical yield strength as compared to pure copper. For example, the copper-beryllium alloy having 1.9% by weight beryllium may have a conductivity approximately 17% that of pure copper, while the alloy having 0.4% by weight beryllium may have a conductivity approximately 51% that of pure copper. Both alloys, however, are substantially more resistant to corrosion than pure copper and therefore better suited for use within rechargeable batteries where the internal temperatures may be 300 degrees Celsius or more. In yet other embodiments, the second portion 44 may be formed of aluminum or aluminum alloys having a desired conductivity for a given operating temperature range.

The first portion 42 is joined to the second portion 44 by a seam 46. In an embodiment, the seam 46 is a weld seam formed by an electron-beam weld process. The seam 46 has a width 88, such as illustrated in FIG. 4. It has been found that an electron-beam weld joining a first portion 42 of nickel to a second portion 44 of a copper-beryllium alloy provides improved electrical conductivity. In an embodiment, the electron-beam weld process partially melts the nickel and copper-beryllium alloy adjacent the seam 46 resulting in the metals joining with reduced mixing of the material. Mixing of materials in a welded seam has been found to increase electrical resistance. By reducing the mixing of the nickel and copper-beryllium alloys through the use of an electron-beam weld process, an electrical interconnect is created with desirable electrical resistance properties. In addition, an electron beam weld process may provide a narrow seam 46. In one embodiment, the weld seam 46 is no greater than 2.0 millimeters in width. In another embodiment, the weld seam 46 has an average width of less than 2.0 millimeters over the length of the seam. In other embodiments, the seam 46 may have an average width of no more than 0.5 millimeters over the length of the seam. As used herein, the width 88 of the seam may be measured as indicated in FIG. 4 and may be measured along the length of the seam which defines the junction between the first portion 42 and the second portion 44 of the electrical interconnect. In other embodiments, the seam 46 is formed by an ultrasonic weld process to create a solid state weld. In a solid state weld, the mixing of material between the first portion and the second portion may be substantially reduced providing a desired electrical conductivity for the assembled interconnect.

A process of manufacturing electrical interconnects is also disclosed. Referring now to FIG. 5, a first material 72, such as nickel, may be joined to a second material 74, such as the copper-beryllium alloys previously discussed, in a strip as illustrated in FIG. 5. The first material 72 may be joined to the second material 74 to form a hybrid strip 70 of a desired length. The length of the hybrid strip 70 produced may depend upon the capabilities of the manufacturing equipment, however, fabrication of longer strips may result in a more economical production process. The hybrid strip 70 may be rolled to reduce the thickness of the strip to a desired thickness 90 (see FIG. 4) for the electrical interconnects. In one embodiment, an electrical interconnect has a thickness 90 of approximately 1.2 millimeters, such as between 1.0 millimeters and 1.4 millimeters. In another embodiment, an electrical interconnect has a thickness 90 of approximately 2.0 millimeters, such as between 1.8 millimeters and 2.2 millimeters. In yet other embodiments, an electrical interconnect has a thickness 90 of between 1.0 and 2.2 millimeters. The thickness 90 of the electrical interconnect, in combination with the width and shape, may be selected to provide a desired electrical resistance for the materials used. In addition, the thickness 90 may be selected to facilitate the manufacturing process. By reducing the thickness of the electrical interconnect, the ability to weld the interconnect to the terminals of the electrochemical cells may be improved. The hybrid strip 70 may be stamped or cut to form individual electrical interconnects in the shape and configuration desired for a given application. In some embodiments, after being formed into the desired configuration the electrical interconnect is annealed to improve the strength of the interconnect and specifically the seam.

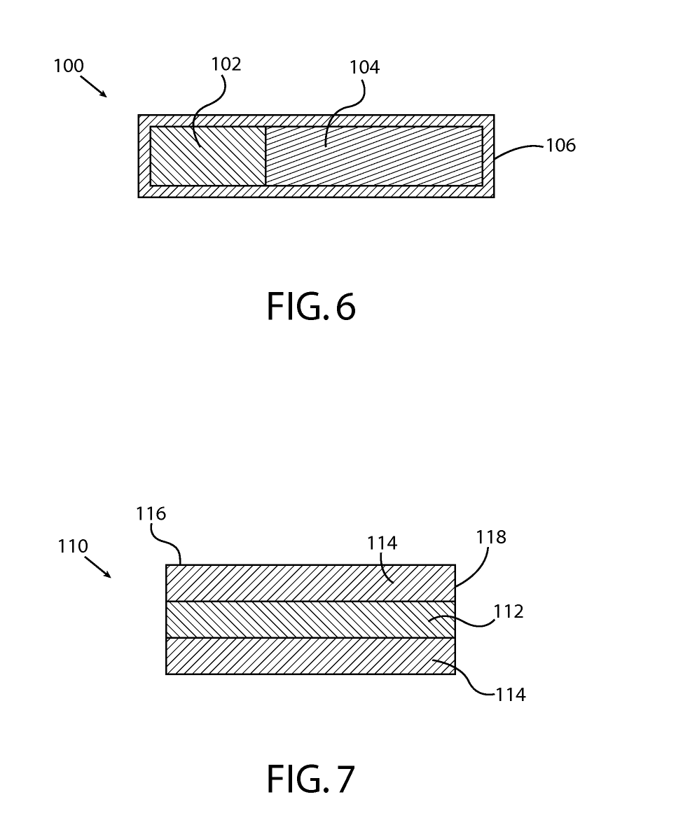

Referring now to FIG. 6, in yet another embodiment, an electrical interconnect 100 includes a first portion 102 of a first conductive material and a second portion 104 of a second conductive material. Electrical interconnects are used inside rechargeable batteries where operating temperatures may exceed 300 degrees Celsius or more over many months or years while the battery is in service. In an embodiment, an electrical interconnect 100 further includes a corrosion resistant coating 106 over the first portion 102 and the second portion 104 to protect the electrical interconnect from oxidation and/or corrosion within the rechargeable battery. In one embodiment, the corrosion resistance coating is electroplated nickel deposited over the interconnect to protect the second portion from corrosion. Some prior interconnects were formed entirely of nickel to reduce oxidation and corrosion related problems, however, the reduced conductivity of nickel as compared to copper or copper alloys resulted in reduced performance of rechargeable battery systems. By providing a nickel coating to limit corrosion, the second portion 104 of the electrical interconnect 100 may be formed of a highly conductive material, such as copper or a copper alloy that might not otherwise be useable in the operating environment within a rechargeable battery. In other embodiments, a corrosion resistant coating may include chromium, silver, gold, titanium, platinum, or tantalum.

Referring now to FIG. 7, another embodiment of an electrical interconnect 110 is disclosed. The electrical interconnect 110 includes a first end 116 configured to be secured to a first terminal of a first electrochemical cell, and a second end 118 configured to be secured to a second terminal of a second electrochemical cell. In this manner, the electrical interconnect functions in a similar manner to the embodiments previously discussed. The electrical interconnect 110 further includes an inner conductive material 112 extending between the first end and the second end, and an outer conductive material 114 at least partially covering the inner conductive material. The outer conductive material 114 is a different material than the inner conductive material 112. In various embodiments, the outer conductive material 114 is clad onto the inner conductive material to form the electrical interconnect.

The electrical interconnect 110 may be formed by hot or cold rolling a sheet of the inner conductive material between sheets of the outer conductive material. The outer conductive material may substantially cover a top and bottom surface of the inner conductive material. In embodiments, the outer conductive material may also cover the sides of the inner conductive material, such that the inner conductive material is fully enclosed in the outer conductive material. In other embodiments, the inner conductive material may be exposed along the edges particularly when the materials are joined in a rolling operation and then cut or stamped to the desired size and shape. In either case, the electrical interconnect 110 includes three layers, with the outer conductive material 114 forming the outer layers and the inner conductive material forming the middle layer.

In embodiments, the inner conductive material 112 may be copper or a copper-beryllium alloy. As previously discussed, copper and some copper alloys are susceptible to oxidation and/or corrosion when used inside rechargeable batteries. Moreover, copper and copper alloys may be difficult to weld to steel or other materials used in the terminals of electrochemical cells. In other embodiments, the inner conductive material 112 may be aluminum or an aluminum alloy or other highly conductive metals suitable for use in a given application. The outer conductive material 114, such as nickel, is provided to protect the inner conductive material from oxidation and corrosion. The outer conductive material 114 further improves the manufacturability of the rechargeable battery as nickel and nickel alloys are reliably weldable to many materials including steels. In other embodiments, the outer conductive material may be chromium or a chromium alloy. In embodiments, the electrical interconnect 110 may further includes a coating, such as the corrosion resistant coatings previously discussed. In one embodiment, an electrical interconnect is formed by hot or cold rolling sheets of the inner and outer conductive materials, to form a hybrid sheet having three layers. The hybrid sheet is then cut to the shape and configuration desired for the electrical interconnect. In some embodiments, the inner conductor may remain exposed along the cut edges. In other embodiments, the electrical interconnect is coated with a corrosion resistant coating, such as electroplated nickel, to provide protection to the inner conductive material that might otherwise be exposed along the edges of the interconnect. In many embodiments, the corrosion resistant coating is formed by the same conductive material used in outer conductive material.

The thickness of the inner and outer conductive materials may be selected to achieve a desired electrical and mechanical performance for the electrical interconnect. In one embodiment, the inner material is copper having a thickness of approximately 0.4 millimeters, and the outer material is nickel having a thickness of 0.4 millimeters on each side of the inner material. In another embodiment, the inner material is copper having a thickness of approximately 0.6 millimeters, and the outer material is nickel having a thickness of 0.3 millimeters on each side of the inner material. In various embodiments, the thickness of each sheet of the outer conductive material is at least 10% or at least 20% of the overall thickness of the electrical interconnect. By providing sufficient outer conductive material, the electrical interconnect may maintain its low resistance, corrosion resistance and weldable properties when the first end and the second end of the interconnect are welded to the terminals of electrochemical cells.

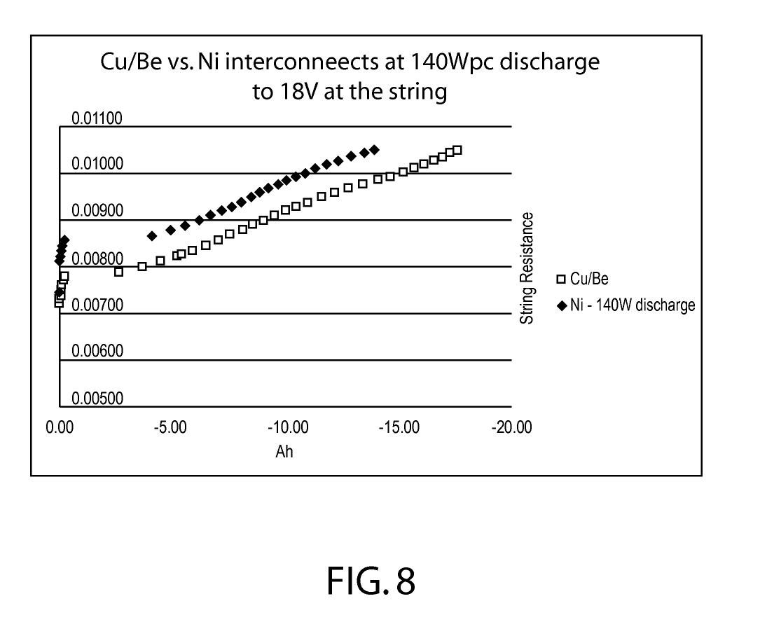

Embodiments of the presently disclosed electrical interconnects may provide improved electrical performance characteristics as compared to prior designs. Referring now to FIG. 8, the performance of a prior pure nickel interconnect (designated Ni) is compared to an interconnect constructed substantially as shown in FIG. 2, having a first portion of nickel and a second portion of a copper-beryllium alloy (designated CuBe). Each interconnect was tested during discharge of a rechargeable battery at 140 watts per cell constant power and the string resistance was monitored during the discharge operation. As shown, for a given amp-hour (Ah), the string resistance is reduced when using the CuBe interconnect as compared with the prior Ni interconnect. Moreover, the time at power was increased from 12.1 to 15.6 minutes. Embodiments of the electrical interconnect presently disclosed may result in savings greater than two watts per cell. For rechargeable batteries having tens or hundreds of cells, the power savings afforded may be substantial.

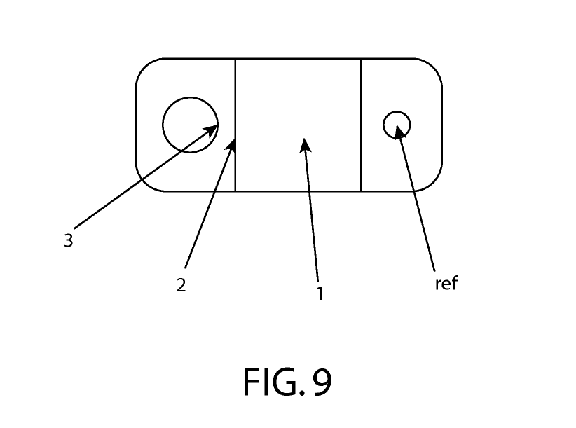

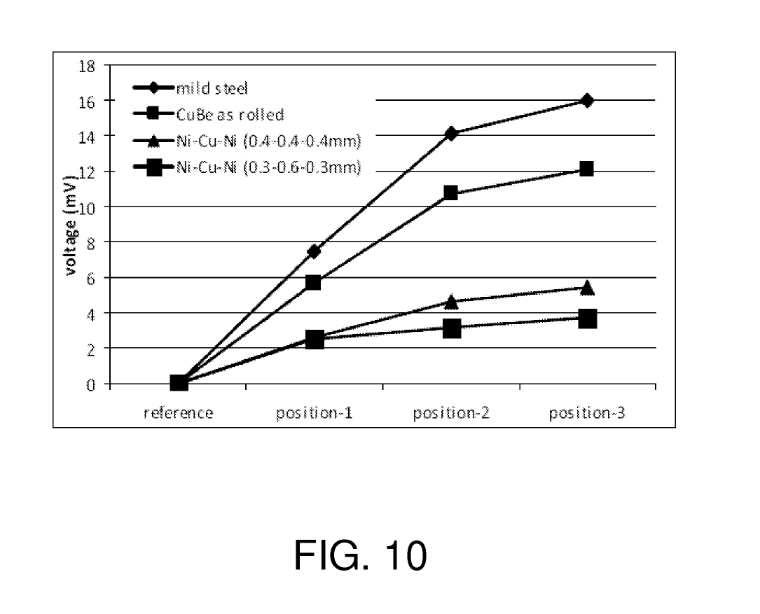

Referring now to FIGS. 9 and 10, the electrical performance of several electrical interconnects is compared and illustrated. The resistance of four electrical interconnects was measured at 22° C. using a fixed 75 Amp current and a test setup as illustrated in FIG. 9. The voltage drop across each of the electrical interconnects was measured from a reference location (designated as “ref”) to each of three locations as generally depicted. Referring to FIGS. 1 and 9, the “ref” location generally corresponds to the connection point between the interconnect and the first terminal of the electrochemical cell, and the location designated “3” correspond to the point of connection between the interconnect and the second terminal of the electrochemical cell. The first interconnect tested was formed of mild steel and represents a prior interconnect used in some rechargeable battery systems. The second interconnect includes a first portion of nickel and a second portion of copper-beryllium alloy as previously discussed. The third and forth electrical interconnects tested each include an inner conductive material of copper (Cu) and an outer conductive material of nickel (Ni) having the thicknesses as illustrated in the table below. As shown in the table, and depicted in FIG. 10, each of the three hybrid electrical interconnects performed better than the mild steel interconnect as demonstrated by the reduced voltage drop and corresponding reduced electrical resistance at each of the three test locations.

| | | CuBe as | Ni—Cu—Ni | Ni—Cu—Ni |
|---|---|---|---|---|
| | mild steel | rolled | (0.4-0.4-0.4 mm) | (0.3-0.6-0.3 mm) |
| | mV | mV | mV | mV |
| reference | 0 | 0 | 0 | 0 |
| position-1 | 7.5 | 5.7 | 2.6 | 2.5 |
| position-2 | 14.1 | 10.7 | 4.6 | 3.2 |
| position-3 | 16 | 12.1 | 5.4 | 3.7 |
| | mOhm | mOhm | mOhm | mOhm |
| position-1 | 0.100 | 0.076 | 0.035 | 0.033 |
| position-2 | 0.188 | 0.143 | 0.061 | 0.043 |
| position-3 | 0.213 | 0.161 | 0.072 | 0.049 |

The presently disclosed electrical interconnects provide substantially reduced resistance increasing the efficiency of a rechargeable battery. At operating temperatures within a rechargeable battery, such as 300° C., the resistance of the electrical interconnects increases. For example, the mild steel and other prior art interconnects may have resistance well in excess of 0.5 ohms at the elevated temperatures within a rechargeable battery resulting in the increased losses and reduced time at power illustrated in FIG. 8. In embodiments, the electrical interconnects presently disclosed provide a lower resistance at these elevated temperatures. In one embodiment, the presently disclosed electrical interconnect may have a resistance of less than 0.5 ohms. In other embodiments, the presently disclosed electrical interconnect may have a resistance of less than 0.200 ohms, which is less than the resistance of a prior art mild steel interconnect even at lower temperatures. The reduced resistance of the electrical interconnect may be achieved by selecting conductive materials having lower resistance and/or a lower coefficient of resistance. In addition, the portion of each conductive material may be varied to further improve the overall resistance achieved at the battery operating temperature, such as by varying the size of the first portion or the thickness of the outer conductive material as previously discussed.

By reducing resistance and the corresponding power losses, a rechargeable battery may be constructed using the presently disclosed electrical interconnects using fewer electrochemical cells while maintaining the same output voltage and power. An electrical interconnect according to the present disclosure may also provide desirable electrical, mechanical, and corrosion resistance properties for use in a rechargeable battery. In this manner, the electrical interconnects may improve the performance of rechargeable batteries as compared to those that are currently available.

The electrical interconnects presently disclosed may be used to assemble rechargeable batteries having these improved characteristics. In an embodiment, a method of assembling a rechargeable battery includes providing a plurality of electrochemical cells, each cell having a first terminal and a second terminal; providing a plurality of electrical interconnects, each interconnect having a first portion configured to be secured to the first terminal of one of the electrochemical cells, and a second portion configured to be secured to the second terminal of a different one of the electrochemical cells, wherein the first portion of each of the electrical interconnects is formed of a first conductive material and the second portion of each of the electrical interconnects is formed of a second conductive material different than the first conductive material; securing the first portion of one of the electrical interconnects to the first terminal of said one of the electrochemical cells; and securing the second portion of said one of the electrical interconnects to the second terminal of said different one of the electrochemical cells. Methods such as these may be used to assemble a rechargeable battery that includes a plurality of electrochemical cells, each cell having a first terminal and a second terminal; and a plurality of electrical interconnects, in which each electrical interconnect includes a first portion secured to the first terminal of one of the electrochemical cells, and a second portion secured to the second terminal of a different one of the electrochemical cells. The first portion of each of the electrical interconnects is a first conductive material and the second portion of each of the electrical interconnects is a second conductive material different than the first conductive material. In some embodiments, the first terminal of each electrochemical cell is formed of a third conductive material and the second terminal of each electrochemical cell is formed of a fourth conductive material different than the third conductive material. In one embodiment, the third conductive material may comprise steel and the fourth conductive material may comprise nickel or a nickel alloy. In another embodiment, the first portion and the second portion of the interconnect are secured to the terminals of the electrochemical cells by welding as previously discussed.

In another embodiment, a method of assembling a rechargeable battery includes providing a plurality of electrochemical cells, each cell having a first terminal and a second terminal; providing a plurality of electrical interconnects, with each interconnect having a first portion configured to be secured to the first terminal of one of the electrochemical cells, and a second portion configured to be secured to the second terminal of a different one of the electrochemical cells. Each of the plurality of electrical interconnects is formed of a sheet of an inner conductive material clad with sheets of an outer conductive material, in which the inner conductive material is different than the outer conductive material. The method also includes securing the first portion of one of the electrical interconnects to the first terminal of said one of the electrochemical cells; and securing the second portion of said one of the electrical interconnects to the second terminal of said different one of the electrochemical cells. Methods such as these may be used to assemble a rechargeable battery having a plurality of electrochemical cells, each cell having a first terminal and a second terminal, and a plurality of electrical interconnects, with each interconnect having a first portion secured to the first terminal of one of the electrochemical cells, and a second portion secured to the second terminal of a different one of the electrochemical cells. In embodiments, each of the plurality of electrical interconnects is formed of a sheet of an inner conductive material clad on opposite sides with sheets of an outer conductive material, where the inner conductive material is different than the outer conductive material. In some embodiments, the first terminal of each electrochemical cell is formed of a first conductive material and the second terminal of each electrochemical cell is formed of a second conductive material different than the first conductive material.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not different from the literal language of the claims, or if they include equivalent structural elements with insubstantial differences from the literal language of the claims.

What is claimed is:

1. An electrical interconnect comprising:
an inner conductive material having a top surface and a bottom surface; and
an outer conductive material different from the inner conductive material, wherein the outer conductive material is clad on the top and bottom surfaces of the inner conductive material,
wherein the electrical interconnect is configured to be secured to a first terminal of a first electrochemical cell and a second terminal of a second electrochemical cell.

2. The electrical interconnect of claim 1, wherein the outer conductive material comprises nickel and wherein the inner conductive material comprises copper or a copper alloy.

3. The electrical interconnect of claim 2, wherein the second conductive material comprises a copper-beryllium alloy.

4. The electrical interconnect of claim 1, wherein the first conductive material comprises nickel or a nickel alloy and the second conductive material comprises aluminum or an aluminum alloy.

5. The electrical interconnect of claim 1, wherein the electrical interconnect is manufactured by hot cladding the outer conductive material to the inner conductive material.

6. The electrical interconnect of claim 1, wherein the electrical interconnect is manufactured by cold cladding the outer conductive material to the inner conductive material.

7. The electrical interconnect of claim 1 further comprising:
a corrosion resistant coating that encloses the inner conductive material and the outer conductive material.

8. The electrical interconnect of claim 7, wherein the corrosion resistant coating comprises at least one of electroplated nickel, chrome, silver, gold, titanium, platinum, tantalum, or alloys thereof.

9. The electrical interconnect of claim 1, wherein the electrical interconnect has a thickness and wherein the outer conductive material clad to the top surface and the bottom surface of the inner conductive material is at least 10% of the thickness of the electrical interconnect.

10. The electrical interconnect of claim 1, wherein the electrical interconnect has an electrical resistance of no more than 0.5 ohms at 300 degrees Celsius measured between a point of connection of the interconnect with the first terminal of the first electrochemical cell and a point of connection of the interconnect with the second terminal of the second electrochemical cell.

11. A method of manufacturing an electrical interconnect comprising:
joining a first conductive material to a second conductive material to form a hybrid strip;
cutting the hybrid strip to form a plurality of electrical interconnects;
coating each of the plurality of interconnects with a corrosion resistant coating; and
annealing each of the plurality of electrical interconnects.

12. The method of manufacturing an electrical interconnect of claim 11, wherein the first conductive material comprises nickel or a nickel alloy and where the second conductive material comprises copper or a copper alloy.

13. The method of manufacturing an electrical interconnect of claim 11, wherein joining the first conductive material to the second conductive material comprises welding the first conductive material to the second conductive material with an electron beam weld or a solid state weld.

14. A rechargeable battery comprising:
a plurality of electrochemical cells, each cell having a first terminal and a second terminal; and
a plurality of electrical interconnects, each interconnect having a first portion secured to the first terminal of one of the electrochemical cells, and a second portion secured to the second terminal of a different one of the electrochemical cells,
wherein each of the plurality of electrical interconnects comprise a sheet of an inner conductive material clad on opposite sides with sheets of an outer conductive material, wherein the inner conductive material is different than the outer conductive material.

15. The rechargeable battery of claim 14, wherein the first terminal of each electrochemical cell comprises a first conductive material and the second terminal of each electrochemical cell comprises a second conductive material different than the first conductive material.

16. A method of assembling a rechargeable battery comprising:
providing a plurality of electrochemical cells, each cell having a first terminal and a second terminal;
providing a plurality of electrical interconnects, each electrical interconnect having a first portion configured to be secured to the first terminal of one of the electrochemical cells, and a second portion configured to be secured to the second terminal of a different one of the electrochemical cells, wherein each of the plurality of electrical interconnects comprise a sheet of an inner conductive material clad with sheets of an outer conductive material, and wherein the inner conductive material is different than the outer conductive material;
securing the first portion of one of the electrical interconnects to the first terminal of said one of the electrochemical cells; and
securing the second portion of said one of the electrical interconnects to the second terminal of said different one of the electrochemical cells.

17. The method of assembling a rechargeable battery as claimed in claim 16, wherein securing the first portion of said one of the electrical interconnects to the first terminal of said one of the electrochemical cells comprises welding the first portion to the first terminal; and wherein securing the second portion of said one of the electrical interconnects to the second terminal of said different one of the electrochemical cells comprises welding the second portion to the second terminal.
